(19) United States
(12) Patent Application Publication
(10) Pub. No.: US 2013/0291877 A1
(43) Pub. Date: Nov. 7, 2013

(54) RESPIRATOR HAVING MOTTLED APPEARANCE

(71) Applicants: Nhat Ha T. Nguyen, Woodbury, MN (US); John M. Brandner, St. Paul, MN (US); Seyed A. Angadjivand, Woodbury, MN (US)

(72) Inventors: Nhat Ha T. Nguyen, Woodbury, MN (US); John M. Brandner, St. Paul, MN (US); Seyed A. Angadjivand, Woodbury, MN (US)

(73) Assignee: 3M Innovative Properties Company

(21) Appl. No.: 13/465,840

(22) Filed: May 7, 2012

(51) Int. Cl. A41D 13/11; B23P 11/00

(52) U.S. Cl. 128/863; 29/428

(57) ABSTRACT

A filtering face-piece respirator 10 that comprises a mask body 12 and a harness 14 that is attached to the mask body 12. The mask body 12 comprises a shaping layer 20 and a filtering structure 22 that contains a filtering layer 32. The filtering structure 22 also comprises an outer cover web 36b that includes colored melt-blown fibers and staple fibers. The use of colored melt-blown fibers and staple fibers in an outer cover web provides the respirator with a mottled colored appearance—that is, the color does not appear uniform over the outer surface of the outer cover web.

The present invention pertains to a filtering face-piece respirator that has an outer cover web that contains colored melt-blown fibers and staple fibers.

### BACKGROUND

Respirators are commonly worn over the breathing passages of a person for at least one of two common purposes: (1) to prevent impurities or contaminants from entering the wearer's respiratory system; and (2) to protect other persons or things from being exposed to pathogens and other contaminants exhaled by the wearer. In the first situation, the respirator is worn in an environment where the air contains particles that are harmful to the wearer, for example, in an auto body shop. In the second situation, the respirator is worn in an environment where there is risk of contamination to other persons or things, for example, in an operating room or clean room.

Some respirators are categorized as being “filtering face-pieces” because the mask body itself functions as the filtering mechanism. Unlike respirators that use rubber or elastomeric mask bodies in conjunction with attachable filter cartridges or filter liners (see, e.g., U.S. Pat. No. RE39,493 to Yuschak et al. and U.S. Pat. No. 5,094,236 to Tayebi) or insert-molded filter elements (see, e.g., U.S. Pat. No. 4,790,306 to Braun), filtering face-piece respirators have the filter media extend over much of the whole mask body so that there is no need for installing or replacing a filter cartridge. As such, filtering face-piece respirators are relatively light in weight and easy to use.

Typically filtering face-piece respirators are made from polymeric nonwoven fibrous materials. These polymeric layers constitute a filtering structure that contains a filtering layer that often has a cover web located on each side of it. The cover webs are used to protect the filter media and to retain any fibers that may come loose from that media. Conventional cover webs regularly contain spunbonded fibers that, like the filtering layers residing within them, appear white under natural lighting conditions due to the refractive index of the polymer and surface area of the fiber. As such, many of the filtering face-piece respirators that are sold today exhibit a white appearance. To provide respirators that display a different color, pigments are often added to the spunbond fibers in the outer cover web. The resulting product then exhibits the color of the dye or pigment rather than the white appearance that the mask would normally exhibit. The intended color appears generally uniform throughout the outer surface of the mask body.

### SUMMARY OF THE INVENTION

The present invention provides a filtering face-piece respirator that comprises a mask body and a harness that is attached to the mask body. The mask body comprises a shaping layer and a filtering structure that contains a filtering layer. The filtering structure also comprises an outer cover web that includes colored melt-blown fibers and staple fibers.

The use of colored melt-blown fibers and staple fibers in an outer cover web provides the respirator with a mottled colored appearance—that is, the color does not appear uniform over the outer surface of the outer cover web. There are regions where the color is more intense or prominent, and there are other regions where the color is less pronounced or subdued. The difference in degrees of hue and intensity creates a unique appearance in the final product. The melt-blown fibers, because of the nature of the melt-blowing process, become randomly distributed throughout the outer cover web. The random distribution causes the variation in appearance of color in the outer surface of the mask body. When the color is blue, the mottled look can create a denim appearance on the outer surface of the mask body. Denim is an appearance that is widely desired and accepted by many consumers.

### GLOSSARY

The terms set forth below will have the meanings as defined:

“comprises (or comprising)” means its definition as is standard in patent terminology, being an open-ended term that is generally synonymous with “includes”, “having”, or “containing”. Although “comprises”, “includes”, “having”, and “containing” and variations thereof are commonly-used, open-ended terms, this invention also may be suitably described using narrower terms such as “consists essentially of”, which is semi open-ended term in that it excludes only those things or elements that would have a deleterious effect on the inventive respirator in serving its intended function;

“clean air” means a volume of atmospheric ambient air that has been filtered to remove contaminants;

“colored” means displaying a color other than white;

“coextensively” means extending parallel to;

“contaminants” means particles (including dusts, mists, and fumes) and/or other substances that generally may not be considered to be particles (e.g., organic vapors, et cetera) but which may be present in air, including air in an exhale flow stream;

“cover web” means a nonwoven fibrous layer that is not primarily designed for filtering contaminants or that is not the primary filtering layer;

“denier” means the weight in grams of 9,000 meters of filament;

“exterior gas space” means the ambient atmospheric gas space into which exhaled gas enters after passing through and beyond the mask body and/or exhalation valve;

“filtering face-piece” means that the mask body itself is designed to filter air that passes through it; there are no separately identifiable filter cartridges, filter liners, or insert-molded filter elements attached to or molded into the mask body to achieve this purpose;

“filter layer”, “filtration layer”, or “primary filtering layer” means one or more layers of air-permeable material, which layer(s) is primarily adapted for the purpose of removing contaminants (such as particles) from an air stream that passes through it;

“filtering structure” means a construction that is designed for filtering air;

“harness” means a structure or combination of parts that assists in supporting the mask body on a wearer's face;

“integral” means that the parts in question cannot be separated without compromising or destroying the structure as a whole;

“juxtaposed” or “juxtapositioned” means placing the major surfaces at least in contact with each other;

“interior gas space” means the space between a mask body and a person's face;

“mask body” means an air-permeable structure that is designed to fit over the nose and mouth of a person, that filters air that passes through it, and that helps define an interior gas space separated from an exterior gas space;

“melt-blown” or “melt-blowing” means formed from the extrusion of a molten material through a plurality of orifices to form filaments while contacting the filaments with air or other attenuating fluid that attenuates the filaments into fibers, and thereafter collecting a layer of the attenuated fibers;

“melt-blown fibers” means fibers prepared by melt-blowing;

“melting point” means the temperature at which a solid material begins to flow;

“mesh” means a plastic web that has sufficient structural integrity to retain a desired shape after being molded, that has a network of open spaces through which air can readily pass, and that (when laid flat before being molded) is substantially larger in first and second dimensions than in a third;

“mesofiber” means fibers having an effective fiber diameter of greater than 10 micrometers;

“microfiber” means fibers having an effective fiber diameter of 1 to 10 micrometers;

“mid region” means an area between an apex region and the mask body perimeter;

“mold” means a device that is used to form a product into a desired shape or configuration though application of heat and/or pressure;

“molded” or “molding” means forming into a desired shape using heat and pressure;

“mottled” means a variegated appearance of color;

“multitude” means 100 or more;

“nose clip” means a mechanical device (other than a nose foam), which device is adapted for use on a mask body to improve the seal at least around a wearer's nose;

“nonwoven” means a structure or portion of a structure in which the fibers are held together by a means other than weaving;

“parallel” means being generally equidistant;

“perimeter” means the outer edge of the mask body, which outer edge would be disposed generally proximate to a wearer's face when the respirator is being donned by a person;

“porous” means air-permeable;

“polymer” means a material that contains repeating chemical units, regularly or irregularly arranged;

“polymeric” and “plastic” each mean a material that mainly includes one or more polymers and may contain other ingredients as well;

“plurality” means two or more;

“respirator” means an air filtration device that is worn by a person on the face over the nose and mouth to provide clean air for the wearer to breathe;

“shaped”, in regard to a respirator mask body, means that the mask body has been molded into a desired face-fitting configuration;

“shaping layer” and “support structure” means a layer that has sufficient structural integrity to retain its molded shape (and the shape of other layers that are supported by it) under normal handling;

“similar” in regard to melting point means the same or within 20° C. to each other;

“solidity” means the percent solids in a web;

“staple fiber” means fibers that are cut to a generally defined length;

“thermally bonding (or bondable) fibers” mean fibers that bond to adjacent plastic items after being heated above their melting point and subsequently cooled;

“upstream” means located before at a point in time in moving fluid stream; and

“web” means a structure that is significantly larger in two dimensions than in a third and that is air permeable.

### BRIEF DESCRIPTION OF THE DRAWINGS

FIG. 1 is a front view of a filtering face-piece respirator 10 in accordance with the present invention.

FIG. 2 is a front view of a respirator 10′ of the present invention having a mesh 24 as a support structure 20 for the mask body 12′.

FIG. 3 is a cross-section of the mask body 12′ shown in FIG. 3.

FIG. 4 is a photograph of a mask shell 38 before having excess material 39 trimmed from the shell 38 along the mask body perimeter.

### DETAILED DESCRIPTION OF PREFERRED EMBODIMENTS

In the practice of the present invention, a filtering face-piece respirator is provided, which comprises a mask body that contains an outer cover web having colored melt-blown fibers and staple fibers. A harness is joined to the mask body for purposes of supporting the mask body over the wearer's nose and mouth. The outer cover web is part of a filtering structure that also contains a filtering layer. The use of colored melt-blown fibers in conjunction with the staple fibers creates a mottled appearance on the outer surface of the mask body. The mottled look may be beneficial, for example, when attempting to give the mask body a denim or similar type look. Alternatively, a camouflage appearance may be provided by using green and brown fibers or brown and tan fibers. For example, the melt-blown fibers could be colored green, and the staple fibers could be colored brown.

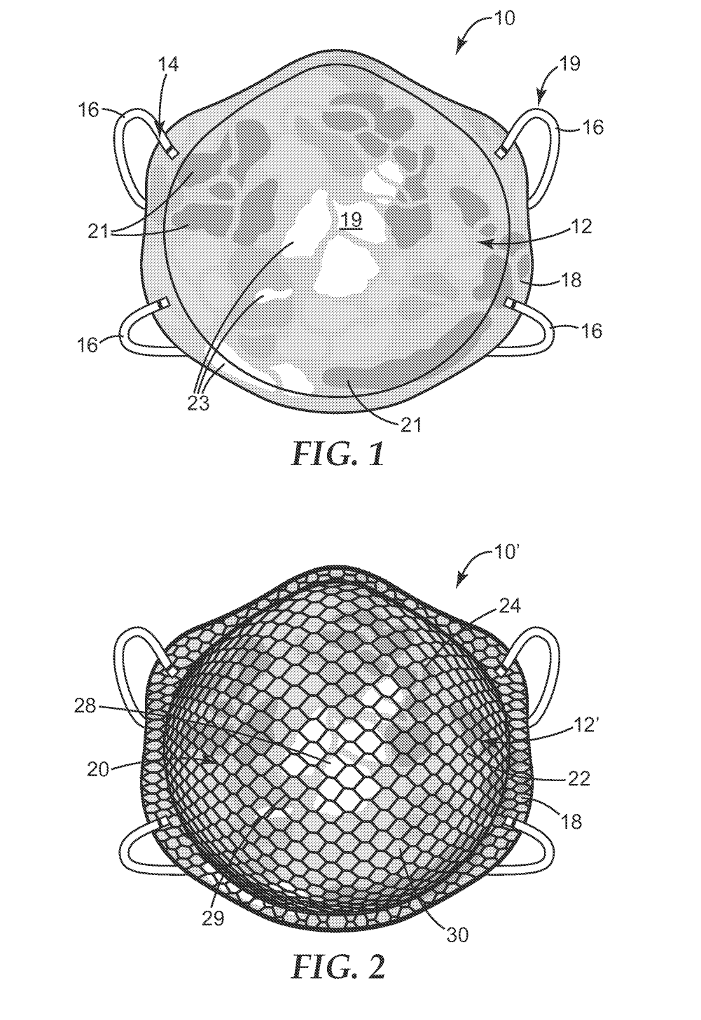

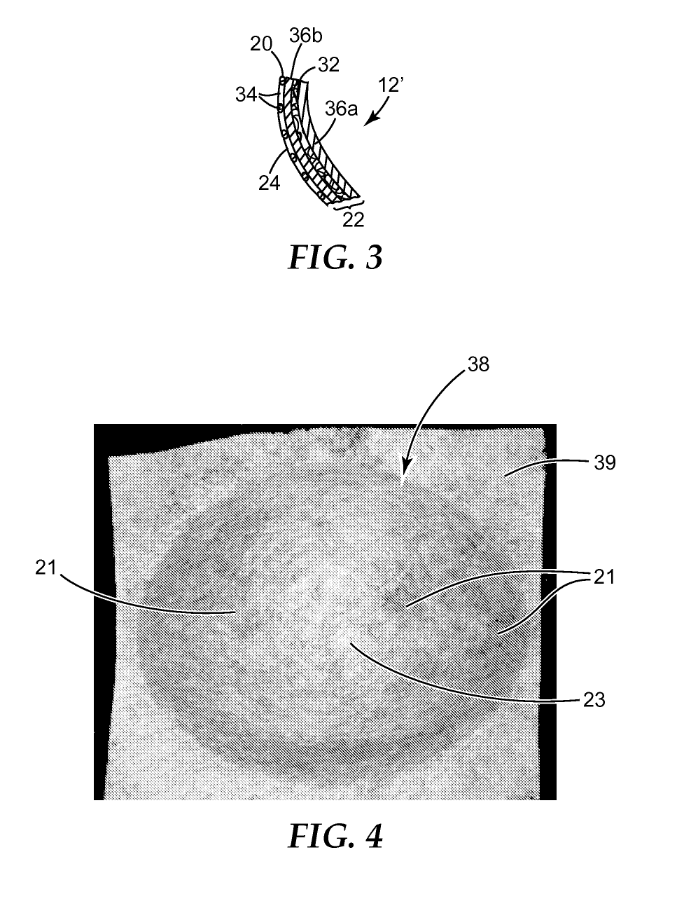

FIG. 1 shows an example of a filtering face-piece respiratory mask 10 that comprises a mask body 12 and a mask harness 14. The harness 14 may comprise one or more straps 16 that may be made from an elastic material. The harness straps 16 may be secured to the mask body 12 by a variety of means including adhesive means, bonding means, or mechanical means (see, for example, U.S. Pat. No. 6,729,332 to Castiglione). The harness 16 could be, for example, ultrasonically welded to the mask body 12 or stapled to the mask body. Adjustable buckles may be provided on the harness 14 to allow the straps 16 to be adjusted in length. Fastening or clasping mechanisms also may be attached to the straps 16 to allow the harness 14 to be disassembled when removing the respirator 10 from a person's face and reassembled when donning the respirator 10 onto a person's face. Examples of other harnesses that could possibly be used are described in U.S. Pat. Nos. 5,394,568 to Brostrom et al. and 5,237,986 to Seppala et al. and in EP 608684A to Brostrom et al. The mask body 12 has a periphery 18 that is shaped to contact the wearer's face over the bridge of the nose, across and around the cheeks, and under the chin. The mask body 12 forms an enclosed interior gas space around the nose and mouth of the wearer and can take on a curved, hemispherical shape as shown in the drawings or it may take on other shapes as so desired. A shaping layer may be included in the mask body to create a cup-shaped configuration like the filtering face mask disclosed in U.S. Pat. Nos. 4,536,440 to Berg, 4,807,619 to Dyrud et al. and 4,827,924 to Japuntich. A malleable nose clip can be secured on the outer face of the mask body 12, centrally adjacent to its upper edge, to enable the mask to be deformed or shaped in this region to properly fit over a particular wearer's nose. An Example of a suitable nose clip is shown and described in U.S. Pat. Nos. 5,558,089 and Des. 412,573 to Castiglione. The mask body 12 also may have an optional corrugated pattern or mesh that may extend through all or some of the layers of the central region of the mask body 12 to improve product crush resistance. The respirator 10 has a mottled look on the outer surface 19 of the mask body 12. The outer surface 19 has areas 21 where the colored blown fibers are more concentrated in the outer cover web 36b (FIG. 3); there also are regions 23 where this color is less pronounced. The result is that the color does not appear uniform over of the outer surface 19 of the outer cover web 36b (FIG. 3). These less pronounced regions 23 are areas on the surface of the outer cover web 36b where the staple fibers are more prominent. The differences in degrees of melt-blown fiber density on the outer surface 19 of the mask body 12 are recognizable in the final product when the melt-blown fibers are colored distinct from the staple fibers. The melt-blowing process for making the melt-blown fibers randomly distributes these fibers throughout the outer cover web. This random, non-uniform distribution causes the colored fibers to be more highly concentrated in some areas and less concentrated in others, which creates the mottled appearance.

FIG. 2 shows that the mask body 12′ can have a support structure 20 that provides support for a filtering structure 22 that resides behind the support structure 20. The filtering structure 22 removes contaminants from the ambient air when a wearer of the respirator 10′ inhales. The support structure 20 includes a plastic mesh 24 that is molded into a three-dimensional configuration, which defines the mask body shape. The mesh 20, when in its molded configuration, can provide the structural integrity sufficient for the mask body 12 to retain its intended configuration. The filtering structure 22 may be secured to the support structure 20 at the mask body perimeter 18. The filtering structure 22 also may be secured to the support structure 20 at the apex 28 of the mask body 12 when an exhalation valve (not shown) is secured thereto. The bonding of the mesh 24 to the filtering structure 22 at the perimeter 18 and at the apex 28 may be achieved through ultrasonic welding. Between the perimeter 18 and the apex 28 is the mid region 30 where the mesh and the filtering structure also can be bonded to each other through thermal bonds between the mesh material and the melt-blown fibers that are present in the outer cover web—see copending patent application entitled Molded Respirator Having Outer Cover Web Joined to Mesh, filed on the same day as this patent application (attorney case number 69779US002). As indicated above, the outer cover web comprises melt-blown fibers and staple fibers. At least the melt-blown fibers are bonded to the mesh material. The melt-blown fibers become bonded to the mesh material since they typically have a lower melting point than the fibers that constitute the staple fibers and may share a melting point similar to the plastic materials that constitute the mesh. In addition to providing a lighter or alternative color to the coloring of the melt-blown fibers, the staple fibers typically are commonly provided to preserve loft or decrease web solidity. If desired, the outer cover web may be a prefilter that removes contaminants from the air before the air passes through the filtering layer of the filtering structure. As described below, this may be achieved by imparting electric charge into the fibers, particularly the melt-blown fibers, that are present in the outer cover web.

FIG. 3 shows a cross-section of the mask body 12′, which includes the support structure 20 and the filtering structure 22. The support structure 20 comprises a mesh 24, and the filtering structure 22 comprises one or more layers including a filtering layer 32. The mesh 24 that comprises the support structure 20 typically has a thickness of about 0.5 to 2.0 millimeters (mm), and the strands 34 that comprise the mesh 24 typically have an average cross-sectional area of about 0.2 to 3.2 mm², more typically of about 0.3 to 1.2 mm². The mesh 24 resides on an outer surface of the mask body 12′ and may be made from a variety of polymeric materials. The filtering structure 22 may include one or more cover webs 36a and 36b and the filtration layer 32. The cover webs 36a and 36b may be located on opposing sides of the filtration layer 32 to capture any fibers that could come loose from the filtration layer 32. Typically, the inner cover web 36a is made from a selection of fibers that provide a comfortable feel, particularly on the side of the filtering structure 22 that makes contact with the wearer's face—see U.S. Pat. No. 6,041,782 to Angadjivand et al. The outer cover web 36b contains staple fibers that are distributed throughout and intermingled or intertangled with the colored melt-blown fibers. The masks of the present invention may be molded using the process described in U.S. Pat. No. 7,131,442 to Kronzer et al. In lieu of the mesh 24, the mask body could comprise an inner shaping layer as described in the '442 patent. Although the invention is described in reference to the molded cup-shaped respirators shown in FIGS. 1-3, the respirator also may take the form of a flat-fold respirator. Flat-fold respirators are stored flat but include seams, pleats, and/or folds that allow the mask to be opened into a cup-shaped configuration for use. Examples of flat-fold filtering face-piece respirators are shown in U.S. Pat. Nos. 6,568,392 and 6,484,722 to Bostock et al. and 6,394,090 to Chen

### The Inner Cover Web:

The inner cover web can be used to entrap fibers that may come loose from the mask body and for comfort reasons. The inner cover web typically does not provide any substantial filtering benefits to the filtering structure. The inner cover web preferably has a comparatively low basis weight and is formed from comparatively fine fibers. More particularly, the inner cover web may be fashioned to have a basis weight of about 5 to 50 g/m² (typically 10 to 30 g/m²), and the fibers may be less than 3.5 denier, typically less than 2 denier, and more typically less than 1 denier but greater than 0.1 denier. Fibers used in the inner cover web often have an average fiber diameter of about 5 to 24 micrometers, typically of about 7 to 18 micrometers, and more typically of about 8 to 12 micrometers. The cover web material may have a degree of elasticity, typically, but not necessarily, 100 to 200% at break, and may be plastically deformable.

Suitable materials for the inner cover web may be blown microfiber (BMF) materials, particularly polyolefin BMF materials, for example polypropylene BMF materials (including polypropylene blends and also blends of polypropylene and polyethylene). An inner cover web can be pre-made as described in U.S. Pat. No. 4,013,816 to Sabee et al. The pre-made web may be formed by collecting the fibers on a smooth surface, typically a smooth-surfaced drum or a rotating collector—see U.S. Pat. No. 6,492,286 to Berrigan et al. Spunbond fibers also may be used in assembling an inner cover webs according to the invention.

A typical inner cover web may be made from polypropylene or a polypropylene/polyolefin blend that contains 50 weight percent or more polypropylene. These materials have been found to offer high degrees of softness and comfort to the wearer and also, when the filter material is a polypropylene BMF material, to remain secured to the filter material without requiring an adhesive between the layers. Polyolefin materials that are suitable for use in an inner cover web may include, for example, a single polypropylene, blends of two polypropylenes, and blends of polypropylene and polyethylene, blends of polypropylene and poly(4-methyl-1-pentene), and/or blends of polypropylene and polybutylene. One example of a fiber for the cover web is a polypropylene BMF made from the polypropylene resin “Escorene 3505G” from Exxon Corporation, providing a basis weight of about 25 g/m² and having a fiber denier in the range 0.2 to 3.1 (with an average, measured over 100 fibers of about 0.8). Another suitable fiber is a polypropylene/polyethylene BMF (produced from a mixture comprising 85 percent of the resin “Escorene 3505G” and 15 percent of the ethylene/alpha-olefin copolymer “Exact 4023” also from Exxon Corporation) providing a basis weight of about 25 g/m² and having an average fiber denier of about 0.8. Suitable spunbond materials are available, under the trade designations “Corosoft Plus 20”, “Corosoft Classic 20” and “Corovin PP-S-14”, from Corovin GmbH of Peine, Germany, and a carded polypropylene/viscose material available, under the trade designation “370/15”, from J.W. Suominen OY of Nakila, Finland. Inner cover webs that are used in the invention generally have very few fibers protruding from the web surface after processing and therefore provide a smooth outer surface—see in U.S. Pat. Nos. 6,041,782 to Angadjivand, U.S. Pat. No. 6,123,077 to Bostock et al., and WO 96/28216A to Bostock et al.

### The Outer Cover Web:

The outer cover web typically contains staple fibers that are distributed throughout and intermingled within the network of melt-blown fibers. The melt-blown fibers may comprise an intermingled mixture of microfibers and mesofibers. These melt-blown fibers contain a polymeric material that may have a melting point that is similar to the melting point of the mesh. The melting points typically are within 10° C. of each other. In one embodiment, the web comprises a bimodal mixture of intermingled microfibers and mesofibers. In various embodiments, the microfibers may exhibit a maximum diameter of about 10 micrometers (μm), about 8 μm, or about 5 μm. In additional embodiments, the microfibers may exhibit a minimum diameter of about 0.1 μm, 0.5 μm, or 1 μm. In various embodiments, the mesofibers may exhibit a minimum diameter of about 11 μm, about 15 μm, or about 20 μm. The mesofibers also may exhibit a maximum diameter of about 70 μm, 60 μm, or 50 μm. The outer cover web typically has a thickness of about 0.5 to 30 millimeters (mm), more typically about 2.0 to 10 mm.

The populations of microfibers and mesofibers may be characterized according to a fiber frequency histogram which presents the number of fibers of each given diameter (not including staple fibers). Alternatively, the populations may be characterized by a mass frequency histogram which presents the relative mass of the fibers (not including staple fibers) of each given fiber diameter. The melt-blown fibers may be present in a bimodal fiber diameter distribution such that there is present at least one mode of microfibers and at least one mode of mesofibers. Modes may also be present in a mass frequency histogram, and may or may not be the same as the modes present in the fiber frequency histogram. In various embodiments, a bimodal fiber mixture web may exhibit one or more microfiber modes at a fiber diameter of at least about 0.1 μm, 0.5 μm, 1 μm, or 2 μm. The bimodal fiber mixture web may exhibit one or more microfiber modes at a fiber diameter of at most about 10 μm, 8 μm, or 5 μm of the bimodal fiber mixture web may exhibit a microfiber mode of 1 μm or 2 μm. In various embodiments, a bimodal fiber mixture web may exhibit one or more mesofiber modes at a fiber diameter of at least about 11 μm, 15 μm, or 20 μm and one or more mesofiber modes at a fiber diameter not exceeding about 50 μm, 40 μm, or 30 μm. Such bimodal fiber mixture webs may exhibit at least two modes whose corresponding fiber diameters differ by at least about 50%, 100%, 200%, or 400% of the smaller fiber diameter. Bimodal fiber mixture web histograms may exhibit one or more gaps between a smaller diameter melt-blown fiber population and a larger diameter melt-blown fiber population. The melting point of the melt-blown fibers typically is about 130 to 170° C., more typically 140 to 160° C.

As may be ascertained by viewing, for example, mass frequency histograms, the mesofibers may make up a significant portion of the melt-blown fiber material as measured by weight, and accordingly may provide the web with strength and mechanical integrity. In one embodiment, the mesofibers comprise at least about 30% by weight of the melt-blown fibers. In additional embodiments, the mesofibers comprise at least about 40%, 50%, 60%, or 70% by weight of the melt-blown fibers.

As may be ascertained by viewing, for example, fiber frequency histograms, the microfibers may comprise a majority of the number of fibers in the web, and accordingly may provide the desired ability to entrap fine particles. In one embodiment, there are at least five times as many microfibers as mesofibers. In an alternative embodiment, there are at least ten times as many microfibers as mesofibers; in another embodiment, at least twenty times.

The resins used to make the melt-blown microfibers and mesofibers are commonly of the same polymeric composition. The microfibers and mesofibers may able to melt-bond to each other, either during the melt-blowing process or during a subsequent molding process, depending on the particular conditions used for each process. In an alternative embodiment, the resins used to make the melt-blown fibers (microfibers and mesofibers) are of different polymeric compositions coextruded together.

The resins used to make the microfibers and mesofibers also are commonly of substantially the same melt flow index.

Some examples of fiber-forming resins that may be suitable for melt-blowing include thermoplastic polymers such as polycarbonates, polyesters, polyamides, polyurethanes, block copolymers such as styrene-butadiene-styrene and styrene-isoprene-styrene block copolymers, and polyolefins such as polypropylene, polybutylene, and poly(4-methyl-1-pentene), or combination of such resins. Examples of materials that may be used to make melt-blown fibers are disclosed in U.S. Pat. No. 5,706,804 to Baumann et al.; U.S. Pat. No. 4,419,993 to Peterson; U.S. Reissue Pat. No. Re. 28,102 to Mayhew; U.S. Pat. Nos. 5,472,481 and 5,411,576 to Jones et al.; and U.S. Pat. No. 5,908,598 to Rousseau et al.

For webs that will be charged, the input polymer resin may be essentially any thermoplastic fiber-forming material that will maintain satisfactory electret properties or charge separation. Preferred polymeric fiber-forming materials for chargeable webs are non-conductive resins that have a volume resistivity of 10¹⁴ ohm-centimeters or greater at room temperature (22° C.). Preferably, the volume resistivity is about 10¹⁶ ohm-centimeters or greater. Polymeric fiber-forming materials for use in chargeable webs also preferably are substantially free from components such as antistatic agents that could significantly increase electrical conductivity or otherwise interfere with the ability of the fiber to accept and hold electrostatic charges. Some examples of polymers that may be used in chargeable webs include thermoplastic polymers containing polyolefins such as polyethylene, polypropylene, polybutylene, poly(4-methyl-1-pentene) and cyclic olefin copolymers, and combinations of such polymers. Other polymers that may be used but which may be difficult to charge or which may lose charge rapidly include polycarbonates, block copolymers such as styrene-butadiene-styrene and styrene-isoprene-styrene block copolymers, polyesters such as polyethylene terephthalate, polyamides, polyurethanes, and other polymers that will be familiar to those skilled in the art.

Staple fibers are typically added to a nonwoven web in solidified form. Often, they are made by processes such that the fiber diameter more closely resembles the size of the orifice through which the fiber is extruded. Regardless of their process of manufacture or composition, staple fibers are typically machine cut to a specific predetermined or identifiable length. The length of the staple fibers typically is much less than that of melt-blown fibers, and may be less than 0.6 meters, or less than about 0.3 meters. The staple fibers typically have a length of about Ito 8 centimeters (cm), more typically about 2.5 cm to 6 cm. The average geometric fiber diameter for the staple fibers is generally greater than about 15 μm on average, and in various embodiments can be greater than 20, 30, 40, or 50 μm. The staple fibers generally have a denier of greater than about 3 grams per 9000 meters (g/9,000 m), and equal to or greater than about 4 g/9,000 m. At the upper limit, the denier is typically less than about 50 g/9,000 m and more commonly is less than about 20 g/9000 m to 15 g/9000 m. The staple fibers are typically made from synthetic polymeric materials. Their composition may be chosen so that they can be melt-bonded to each other and/or to the melt-blown fibers during the molding process used to form the shaped respirator body. They also can be made from materials that do not bond to each other or to the melt-blown fibers during a typical molding process. In various embodiments, the outer cover web comprises at least about 30 weight %, 40 weight %, or 45 weight % staple fibers and 70 weight %, 60 weight %, or 55 weight % or less melt-blown fibers. In additional embodiments, the web may comprise at most about 70 weight %, 60 weight %, or 55 weight % staple fibers and greater than 30 weight %, 40 weight %, or 45 weight %, melt-blown fibers.

In certain embodiments in which the staple fiber is not thermally bondable, the bimodal fiber mixture web may offer a superior ability to be molded into a cup-shaped geometry adapted to fit over the nose and mouth of a person without significantly compacting the web. When the staple fiber is thermally bondable, however, greater compaction of the web may occur during a molding process.

Suitable staple fibers may be prepared from polyethylene terephthalate, polyester, polyethylene, polypropylene, copolyester, polyamide, or combinations of one of the foregoing. If bondable, the staple fibers typically retain much of their fiber structure after bonding. The staple fibers may be crimped fibers like the fibers described in U.S. Pat. No. 4,118,531 to Hauser. Crimped fibers may have a continuous wavy, curly, or jagged profile along their length. The staple fibers may comprise crimped fibers that comprise about 10 to 30 crimps per cm. The staple fibers may be single component fibers or multi-component fibers. Examples of commercially available single component fibers that are non-bondable at typically employed molding conditions include T-295, available from Invista Corp of Charlotte, N.C. Examples of commercially available single component thermally bondable staple fibers include T 255, T 259, and T 271, also available from Invista Corp., and Type 410 PETG, Type 110 PETG, available from Foss Manufacturing Inc., of Hampton, N.H. The staple fibers also may be multi-component fibers, where at least one of the components soften during heating to allow the staple fibers to be bonded to each other or to allow the staple fibers to be bonded to melt-blown fibers. The different components may be different types of polymers (e.g. polyester and polypropylene), or may be the same type of polymer but with different melting points. The multi-component fibers may be bicomponent fibers that have a coextensive side-by-side configuration, a coextensive concentric sheath-core configuration, or a coextensive elliptical sheath-core configuration. Examples of bicomponent fibers that may be used as thermally bonded staple fibers include T 254, T 256, available from Invista Corp., polypropylene/polyethylene bicomponent fibers such as (Chisso ES, ESC, EAC, EKC), polypropylene/polypropylene bicomponent fiber (Chisso EPC) and polypropylene/polyethylene-terephthalate bicomponent fiber (Chisso ETC), all available from Chisso Inc. of Osaka, Japan, and Type LMF polyester 50/50 sheath/core staple fiber available from Nan Ya Plastics Corporation of Taipei, Taiwan.

Melt-blown fibers may be prepared by the melt-blowing process described in, for example, U.S. Pat. No. 4,215,682 to Kubik et al. Typically, melt-blown fibers are very long in comparison to staple fibers. Unlike staple fibers, which typically have a specific or identifiable length, melt-blown fibers typically have an indeterminate length. Although melt-blown fibers sometimes are reported to be discontinuous, the fibers generally are long and entangled sufficiently that it is usually not possible to remove one complete melt-blown fiber from a mass of such fibers or to trace one melt-blown fiber from beginning to end. In addition, the diameter of a solidified melt-blown fiber may differ significantly from (e.g., be much smaller than) the size of a source orifice from which the molten fiber precursor was produced. To provide an outer cover web that acts as a prefilter, upstream to the primary filtering layer, the melt-blown fibers in the outer cover web may be electrically charged using, for example, the method described above in the Kubik et al. patent. Alternatively corona charging and hydrocharging methods may be used as described below in the section pertaining to the filter layer to charge the fibers in the outer cover web.

To prepare a respirator with a particular mottled look on the outer surface of the mask, a pigment that causes a particular color hue can be incorporated into the microfiber polymer melt. The mottled color appearance of the web results from variation of the color value, evident at different locations over the coverweb surface, which arise from the web formation process. Darkness or lightness of the color can be varied by changing the shade of the color, for instance, by adding carbon black (to darken the color), or by including titanium dioxide to tint the color to a lighter appearance. Color matching of locations on the coverweb of the mask can be made using Pantones. To prepare a respirator that has a denim look on the outer surface of the mask body, a blue pigment can be added to the polymeric material that comprises the outer cover web. The blue pigment may be selected such that one or more locations on the outer cover web exhibits a color generally matching blue pantones 283-330; 2905-3165, 7457-7470, 801. Typically blue pantones 285-309, 2925-3015, 7457-7461 are selected to provide a blue denim look to the outer surface of the mask body. These blue fibers can be mixed with uncolored or white staple fibers. Other mottled colors that may be used include jade, which can be achieved by mixing forest green melt-blown fibers with white staple fiber. Forest green colors are represented by pantones 326-335, 553-580, 3242-3308, and 7716-7749. Rust colors also may be achieved by adding orange, red, and brown pigments to the melt-blown fibers in combination with the use of white staple fibers. A camouflage appearance may be provided by using brown or tan melt-blown fibers in conjunction with white staple fibers. The color pigments may be added to the polymeric material that comprises the melt-blown fibers typically at about 1 to 10 weight %, or 2 to 5 weight %.

### The Filtering Layer(s):

Filter layers used in a mask body of the invention can be of a particle capture or gas and vapor type. The filter layer also may be a barrier layer that prevents the transfer of liquid from one side of the filter layer to another to prevent, for instance, liquid aerosols or liquid splashes from penetrating the filter layer. Multiple layers of similar or dissimilar filter types may be used to construct the filtration layer of the invention as the application requires. Filters beneficially employed in the mask body of the invention are generally low in pressure drop, for example, less than about 20 to 30 mm H₂O at a face velocity of 13.8 centimeters per second to minimize the breathing work of the mask wearer. Filtration layers additionally are commonly flexible and have sufficient structural integrity so that they do not come apart under expected use conditions. Examples of particle capture filters include one or more webs of fine inorganic fibers (such as fiberglass) or polymeric synthetic fibers. Synthetic fiber webs may include electret charged polymeric microfibers that are produced from processes such as melt-blowing. Polyolefin microfibers formed from polypropylene that are surface fluorinated and electret charged, to produce non-polarized trapped charges, provide particular utility for particulate capture applications. An alternate filter layer may comprise an sorbent component for removing hazardous or odorous gases from the breathing air. Absorbents and/or adsorbents may include powders or granules that are bound in a filter layer by adhesives, binders, or fibrous structures—see U.S. Pat. No. 3,971,373 to Braun. Sorbent materials such as activated carbons, that are chemically treated or not, porous alumna-silica catalyst substrates, and alumna particles are examples of sorbents useful in applications of the invention. U.S. Pat. Nos. 7,309,513 and 7,004,990 to Brey et al., and 5,344,626 to Abler disclose examples of activated carbon that may be suitable.

The filtration layer is typically chosen to achieve a desired filtering effect and, generally, removes a high percentage of particles or other contaminants from the gaseous stream that passes through it. For fibrous filter layers, the fibers selected depend upon the kind of substance to be filtered and, typically, are chosen so that they do not become bonded together during the molding operation. As indicated, the filter layer may come in a variety of shapes and forms. It typically has a thickness of about 0.2 millimeters (mm) to 1 centimeter (cm), more typically about 0.3 mm to 1 cm, and it could be a corrugated web that has an expanded surface area relative to the shaping layer—see, for example, U.S. Pat. Nos. 5,804,295 and 5,656,368 to Braun et al. The filtration layer also may include multiple layers of filter media joined together by an adhesive component—see U.S. Pat. No. 6,923,182 to Angadjivand et al.

Essentially any suitable material that is known (or later developed) for forming a filtering layer may be used as the filtering material. Webs of melt-blown fibers, such as those taught in Wente, Van A., Superfine Thermoplastic Fibers, 48 Indus. Engn. Chem., 1342 et seq. (1956), especially when in a persistent electrically-charged (electret) form are especially useful (see, for example, U.S. Pat. No. 4,215,682 to Kubik et al.). These melt-blown fibers may be microfibers that have an effective fiber diameter less than about 10 micrometers (m) (referred to as BMF for “blown microfiber”), typically about 1 to 9 μm. Effective fiber diameter may be determined according to Davies, C. N., The Separation Of Airborne Dust Particles, Institution Of Mechanical Engineers, London, Proceedings 1B, 1952. Particularly preferred are BMF webs that contain fibers formed from polypropylene, poly(4-methyl-1-pentene), and combinations thereof. Melt-blown webs may be made using the apparatus and die described in U.S. Pat. Nos. 7,690,902, 6,861,025, 6,846,450, and 6,824,733 to Erickson et al. Electrically charged fibrillated-film fibers as taught in van Turnhout, U.S. Pat. No. RE 31,285, also may be suitable, as well as rosin-wool fibrous webs and webs of glass fibers or solution-blown, or electrostatically sprayed fibers, especially in microfiber form. Nanofiber webs also may be used as a filtering layer—see U.S. Pat. No. 7,691,168 to Fox et al. Electric charge can be imparted to the fibers by contacting the fibers with water as disclosed in U.S. Pat. Nos. 6,824,718 to Eitzman et al., 6,783,574 to Angadjivand et al., 6,743,464 to Insley et al., 6,454,986 and 6,406,657 to Eitzman et al., and 6,375,886 and 5,496,507 to Angadjivand et al. Electric charge also may be imparted to the fibers by corona charging as disclosed in U.S. Pat. No. 4,588,537 to Klasse et al. or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the surface of the fibers in the filter layer to improve filtration performance in an oily mist environment—see U.S. Pat. Nos. 5,025,052 and 5,099,026 to Crater et al.; U.S. Pat. Nos. 6,398,847 B1, 6,397,458 B1, and 6,409,806 B1 to Jones et al.; U.S. Pat. No. 7,244,292 to Kirk et al.; 7,244,291 to Spartz et al.; and U.S. Pat. No. 7,765,698 to Sebastian et al. Typical basis weights for electret BMF filtration layers are about 10 to 100 grams per square meter (g/m²). When electrically charged and optionally fluorinated as mentioned above, the basis weight may be about 30 to 200 g/m² and about 40 to 80 g/m², respectively.

### Support Structure:

The support structure may be a nonwoven fibrous web that is moldable and is permeable to air. Support structures of this kind are commonplace and are described in a number of patents—see U.S. Pat. Nos. 6,923,182 to Angadjivand et al., 5,620,545 to Braun et al., 5,307,796 to Kronzer et al. These support structures are regularly referred to as shaping layer. Alternatively, the support structure may take the form of a polymeric mesh. Polymers suitable for mesh formation are thermoplastic materials that can hold their intended position after being molded. The polymeric materials used to make the plastic mesh typically have a Young's modulus of about 14 to 7000 Mega Pascals (MPa), more typically 1500 to 3000 MPa. Thermoplastic materials melt and/or flow upon the application of heat, resolidify upon cooling, and again melt and/or flow upon the application of heat. The thermoplastic material generally undergoes only a physical change upon heating and cooling: no appreciable chemical change occurs. Examples of thermoplastic polymers that can be used to form meshes of the present invention include: polyethylene-vinyl acetate (EVA), polyolefins (e.g., polypropylene and polyethylene), polyvinyl chloride, polystyrene, nylons, polyesters (e.g., polyethylene terephthalate), and elastomeric polymers, (e.g., ABA block copolymers, polyurethanes, polyolefin elastomers, polyurethane elastomers, metallocene polyolefin elastomers, polyamide elastomers, ethylene vinyl acetate elastomers, and polyester elastomers). Blends of two or more materials also may be used in the manufacture of meshes. Examples of such blends include: polypropylene/EVA and polyethylene/EVA. Polypropylene may be preferred for use in the plastic mesh since meltblown fibers are regularly made from polypropylene. Use of similar polymers enables proper welding of the support structure to the filtering structure. Mesh webs that exhibit hexagonal or octagonal shapes in the individual cells generally do not exhibit substantial distortion upon being molded. The cells may be about 20 to 40 mm² in size. The melting temperature of the mesh typically is about 130 to 170° C., more typically 140 to 160°. The melting point may be measured in accordance with differential scanning calorimetry.

### Respirator Components:

The strap(s) that are used in the harness may be made from a variety of materials, such as thermoset rubbers, thermoplastic elastomers, braided or knitted yarn/rubber combinations, inelastic braided components, and the like. The strap(s) may be made from an elastic material such as an elastic braided material. The strap preferably can be expanded to greater than twice its total length and be returned to its relaxed state. The strap(s) also could possibly be increased to three or four times its relaxed state length and can be returned to its original condition without any damage thereto when the tensile forces are removed. The elastic limit thus is generally not less than two, three, or four times the length of the strap when in its relaxed state. Typically, the strap(s) are about 20 to 30 cm long, 3 to 10 mm wide, and about 0.9 to 1.5 mm thick. An example of a strap that may be used in connection with the present invention is shown in U.S. Pat. No. 6,332,465 to Xue et al. Examples of a fastening or clasping mechanism that may be used to joint one or more parts of the strap together is shown, for example, in the following U.S. Pat. Nos. 6,062,221 to Brostrom et al., 5,237,986 to Seppala, and EP1,495,785A1 to Chien and in U.S. Patent Publication 2009/0193628A1 to Gebrewold et al. and International Publication WO2009/038956A2 to Stepan et al.

An exhalation valve may be attached to the mask body to facilitate purging exhaled air from the interior gas space. An exhalation valve may improve wearer comfort by rapidly removing the warm moist exhaled air from the mask interior. See, for example, U.S. Pat. Nos. 7,188,622, 7,028,689, and 7,013,895 to Martin et al.; 7,493,900, 7,428,903, 7,311,104, 7,117,868, 6,854,463, 6,843,248, and 5,325,892 to Japuntich et al.; 7,849,856 and 6,883,518 to Mittelstadt et al.; and RE 37,974 to Bowers. Essentially any exhalation valve that provides a suitable pressure drop and that can be properly secured to the mask body may be used in connection with the present invention to rapidly deliver exhaled air from the interior gas space to the exterior gas space.

To improve fit and wearer comfort, an elastomeric face seal can be secured to the perimeter of the filtering structure. Such a face seal may extend radially inward to contact the wearer's face when the respirator is being donned. Examples of face seals are described in U.S. Pat. Nos. 6,568,392 to Bostock et al., 5,617,849 to Springett et al., and 4,600,002 to Maryyanek et al., and in Canadian Patent 1,296,487 to Yard.

The mask body that is used in connection with the present invention may take on a variety of different shapes and configurations. Although a filtering structure has been illustrated with multiple layers that include a filtration layer and two cover webs, the filtering structure may comprise a combination of these layers and other layers or with modifications as needed. As indicated above, an electret pre-filter may be disposed upstream to a more refined and selective downstream filtration layer. Additionally, sorptive materials such as activated carbon may be disposed between the fibers and/or various layers that comprise the filtering structure. Further, separate particulate filtration layers may be used in conjunction with sorptive layers to provide filtration for both particulates and vapors. The filtering structure could have one or more horizontal and/or vertical lines of demarcation (such as a weld line or fold line) that contribute to its structural integrity.

Mask bodies of the invention can be constructed by providing the layers that comprise the mask body and juxtapositioning them as described above. These layers can be molded into a mask body using the processes described in U.S. Pat. Nos. 4,536,440 to Berg, 4,807,619 to Dyrud et al., and 7,131,442 to Kronzer et al. In making a cup-shaped mask construction, where an outer mesh layer is employed, a pre-formed cup-shaped filtration layer may be prepared. Such a pre-form can be made by first juxtapositioning the inner cover web and filter layer. The layered structure may then be folded in half to form a stacked layered structure that has the filtration layer constituting the outer two layers. The assembly is typically subjected to a heat-sealing procedure to form a generally sinusoidal wave form bond across approximately the upper one quarter of the assembly (near the fold). The waste material between the bond line and the fold may be trimmed, and the resultant layered structure then opened to form a substantially cup-shaped, pre-formed filtration body that has an inner sublayer of the cover web and an outer filter layer. The pre-form can then be placed within a molded mesh/outer cover web combination or with a shaping layer to complete the layers constituting the mask body (see, for example, U.S. Pat. No. 4,807,617 to Dyrud et al.).

### Example

### Outer Cover Web Assembly

The melt-blown fibers used in the outer cover web were formed from a 100 melt flow polypropylene to which had been added 3 weight % blue pigment, product number: CC10054018WE, available from PolyOne Corporation, Elk Grove, Ill., as a colorant. The polymer was fed to a single screw extruder from the Davis Standard Division of Crompton & Knowles Corp. The extruder had a 20:1 length/diameter ratio and a 3:1 compression ratio. A Zenith 10 cubic centimeter per revolution (cc/rev) melt pump metered the flow of polymer to a 50.8 centimeter (cm) wide drilled orifice melt-blowing die. The die, which originally contained 0.3 millimeter (mm) diameter orifices, had been modified by drilling out every ninth orifice to 0.6 mm, thereby providing a 9:1 ratio of the number of smaller size to larger size holes and a 2:1 ratio of larger hole size to smaller hole size. This die design served to deliver a nominal ratio of total larger-diameter fiber extrudate to total smaller-diameter fiber extrudate of approximately 60/40 by volume. The line of orifices had 10 holes/cm hole spacing. Heated air was used to attenuate the fibers at the die tip. The airknife was positioned at a 0.5 mm negative set back from the die tip and a 0.76 mm air gap. No to moderate vacuum was pulled through a medium mesh collector screen at the point of web formation. The polymer output rate from the extruder was about 0.18 kg/cm/hr, the DCD (die-to-collector distance) was about 53 cm, and the air pressure was adjusted as desired. A cover web that had the following properties was produced by adjusting the process. A flow rate of 32 liters per minute (1 μm) was used to measure the pressure drop and to calculate the Effective Fiber Diameter (EFD) and web Solidity:

ΔP=0.36 mm H₂O

Basis weight=1.04 g/5¼ circle (74 gsm)

EFD=21 micron

Thickness=39 mil (0.99 mm)

Solidity=8.3%

A staple fiber addition unit was then started, and combination web that contained melt-blown fiber and staple fiber was formed according to the above conditions by introducing staple fibers into the melt-blown fiber stream. The staple fibers were a 15 denier polyester fiber product and were introduced to form a bimodal fiber mixture web that contained approximately 50% by weight melt-blown fibers and 50% by weight staple fibers.

The combination web properties after adding the staple fiber was as follows:

ΔP=0.20 mm H₂O

Basis weight=2.14 g/5¼ circle (153 gsm)

EFD=28 micron

Thickness=200 mil (5.1 mm)

Solidity=3.0%

### Mask Body Assembly;

1^{st} layer 1 layer of combination web (described above)

2^{nd} layer 2 layers BMF Filter media

3^{rd} layer 1 layer inner coverweb (next to the face) Spunbond PP 0.75 oz coverweb available from PGI, Charlotte, N.C.

The BMF filter web had a basis weight of 0.8 g per a 5.25 inch (13.33 cm) circle (57 grams per square meter), a fiber size of 9 micrometer EFD. The blown microfiber web was corona treated and was hydrocharged as described in U.S. Pat. No. 5,496,507 to Angadjivand et al.

The above-mentioned construction was then molded together to make a finished mask body. The mask body was molded such that the combination web was toward the convex side of the layers. The filter and outer cover web layers were located on the concave side with filter media sandwiched between combination web layer and the outer cover web. The molding of the web layers to form a filtering face-piece respirator was done by placing the nonwoven web layers between mating parts of a hemispherical cup-shaped heated mold that was about 55 mm in height and had a volume of about 310 cm³. The top and bottom halves of the mold were heated to about 115° C. The heated mold was closed to a gap of approximately 1.27 mm for approximately 15 seconds. After this time, the mold was opened, and the molded product was removed and trimmed manually. FIG. 4 shows a molded respirator shell 38 before having excess material 39 trimmed from the shell 38 to create a mask body. As illustrated, the resulting shell 38 has a mottled appearance with lighter uncolored areas 23 and darker colored areas 21. Ultrasonic bonding was then performed on the edges of the molded respirator shell to seal the layers around the mask body perimeter. The harness straps can be attached to the mask body using any of the techniques described above.

This invention may take on various modifications and alterations without departing from its spirit and scope. Accordingly, this invention is not limited to the above-described but is to be controlled by the limitations set forth in the following claims and any equivalents thereof.

This invention also may be suitably practiced in the absence of any element not specifically disclosed herein.

All patents and patent applications cited above, including those in the Background section, are incorporated by reference into this document in total. To the extent there is a conflict or discrepancy between the disclosure in such incorporated document and the above specification, the above specification will control.

What is claimed is:

1. A filtering face-piece respirator that comprises:
(a) a mask body that includes a filtering structure that comprises:
(i) an outer cover web that comprises colored melt-blown fibers and staple fibers; and
(ii) a filter layer; and
(b) a harness that is joined to the mask body.

2. The filtering face-piece respirator of claim 1, wherein the mask body further comprises an outer mesh.

3. The filtering face-piece respirator of claim 1, wherein the staple fibers in the filtering structure are uncolored.

4. The filtering face-piece respirator of claim 1, wherein the melt-blown fibers are colored blue.

5. The filtering face-piece respirator of claim 1, wherein the melt-blown fibers are colored green or tan and the staple fibers are colored green or tan, and wherein the melt-blown fibers and the staple fibers do not have the same color.

6. The filtering face-piece respirator of claim 1, further comprising an inner cover web and a shaping layer, and wherein the filter layer contains melt-blown microfibers.

7. The filtering face-piece respirator of claim 1, wherein the outer cover web contains melt-blown microfibers.

8. The filtering face-piece respirator of claim 1, wherein the outer cover web contains at least about 30 weight percent staple fibers and 70 weight percent or less melt-blown fibers.

9. The filtering face-piece respirator of claim 1, wherein the outer cover web contains at least about 40 weight percent staple fibers and 60 weight percent or less melt-blown fibers.

10. The filtering face-piece respirator of claim 1, wherein the outer cover web contains at least about 45 weight percent staple fibers and 55 weight percent or less melt-blown fibers.

11. The filtering face-piece respirator of claim 4, wherein one or more locations exhibit blue pantones 283-330, 2905-3165, 7457-7470, 80.

12. The filtering face-piece respirator of claim 4, wherein one or more locations exhibit blue pantones 285-309, 2925-3015, 7457-7461.

13. The filtering face-piece respirator of claim 1, wherein the melt-blown fibers contain brown pigment.

14. The filtering face-piece respirator of claim 12, wherein the staple fibers are colored tan.

15. A method of making a filtering face-piece respirator, which method comprises:
(a) assembling a filtering structure that comprises (i) an outer cover web that contains colored microfibers and staple fibers, (ii) a filtration layer that contains electrically-charged microfibers, and (iii) an inner cover web; and
(b) adapting the filtering structure into a mask body; and
(c) securing a harness to the mask body.
